(19) United States
(12) Patent Application Publication
(10) Pub. No.: US 2012/0285613 A1
(43) Pub. Date: Nov. 15, 2012

(54) ANTI-CURLING REINFORCEMENT DEVICE FOR AREA RUG CORNERS

(76) Inventors: Charles Michael Bongiovanni, Baton Rouge, LA (US); Randy Fleniken, Brandon, MS (US)

(21) Appl. No.: 13/468,019

(22) Filed: May 9, 2012

Related U.S. Application Data
(60) Provisional application No. 61/484,328, filed on May 10, 2011.

(51) Int. Cl. B32B 38/10; C09J 7/02

(52) U.S. Cl. 156/249; 428/40.1

(57) ABSTRACT

An anti-curling reinforcement device can be applied to corners of a rug, such as an area rug, to prevent the corners from curling. By adhering to the underside of the rug, and not the floor, the anti-curling reinforcement device does not damage the floor as may occur with double-sided carpet tape. The device utilizes a specially designed shape and structure that straightens and reinforces the corner to prevent further curling and possible damage to the rug. The device straightens, reinforces and adds weight to the rug corner to prevent curling, keeping the corner flat, and preventing possible damage to the rug as well as minimizing tripping hazards from curled corners.

### CROSS-REFERENCE TO RELATED APPLICATIONS

This application claims the benefit of priority of U.S. provisional patent application No. 61/484,328, filed May 10, 2011, the contents of which are herein incorporated by reference.

### BACKGROUND OF THE INVENTION

The present invention relates to rug accessories and, more particularly, to an anti-curling reinforcement device for area rug corners.

Many rugs and tapestries experience corners that curl upward. Curled rug corners are unsightly and, more importantly, unsafe due to tripping hazards and possible damage to the rug. Two-way tape does not work well to prevent corner curling since two-way tape is extremely flexible and does not provide any additional support or strength to the corner of the rug. Tape can also leave damaging adhesive residue on floors.

Another technique used to combat curled rug corners is to place heavy objects on each rug corner for an extended period of time. This does not work since the corners are not reinforced and return to their curled position after removing the items. Moreover, the heavy items placed on the rug corners may, themselves, be unsightly, out of place and may be a hazard for people walking through the room.

As can be seen, there is a need for an improved apparatus to prevent area rug corners from curling.

### SUMMARY OF THE INVENTION

In one aspect of the present invention, a device for treating and preventing corner curl in rugs comprises a device body having an L-shape with outside rounded corners and an inside rounded corner, the device body having a floor side and an adhesive side; an adhesive disposed on the adhesive side of the device body; and an adhesive backing disposed over the adhesive, the adhesive backing adapted to be removed to expose the adhesive.

In another aspect of the present invention, a method for preventing or eliminating curling at corners of rugs comprises removing an adhesive backing disposed over an adhesive applied to a device body of an anti-curling device, the device body having an L-shape with outside rounded corners and an inside rounded corner, the device body having a floor side and an adhesive side; applying the adhesive to a bottom of the rug at a corner thereof, where the L-shape of the device body follows along the corner; and turning the rug back over with the floor side of the device body toward a floor surface.

These and other features, aspects and advantages of the present invention will become better understood with reference to the following drawings, description and claims.

### BRIEF DESCRIPTION OF THE DRAWINGS

FIG. 1 is a perspective view of an anti-curling reinforcement device, in use on an area rug, according to an exemplary embodiment of the present invention;

FIG. 2 is a perspective bottom (floor side) view of the anti-curling reinforcement device of FIG. 1;

FIG. 3 is a bottom view of the anti-curling reinforcement device of FIG. 1;

FIG. 4 is a top (rug side) view of the anti-curling reinforcement device of FIG. 1;

FIG. 5 is a perspective view showing a user removing an adhesive backing film from the anti-curling reinforcement device prior to application to a corner of a rug;

FIG. 6 is a perspective view showing a user applying the anti-curling reinforcement device to a corner of a rug; and

FIG. 7 is a cross-sectional view taken along line 8-8 of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides an anti-curling reinforcement device that can be applied to corners of a rug, such as an area rug, to prevent the corners from curling. By adhering to the underside of the rug, and not the floor, the anti-curling reinforcement device does not damage the floor as may occur with double-sided carpet tape. The device utilizes a specially designed shape and structure that straightens and reinforces the corner to prevent further curling and possible damage to the rug. The device straightens, reinforces and adds weight to the rug corner to prevent curling, keeping the corner flat, and preventing possible damage to the rug as well as minimizing tripping hazards from curled corners.

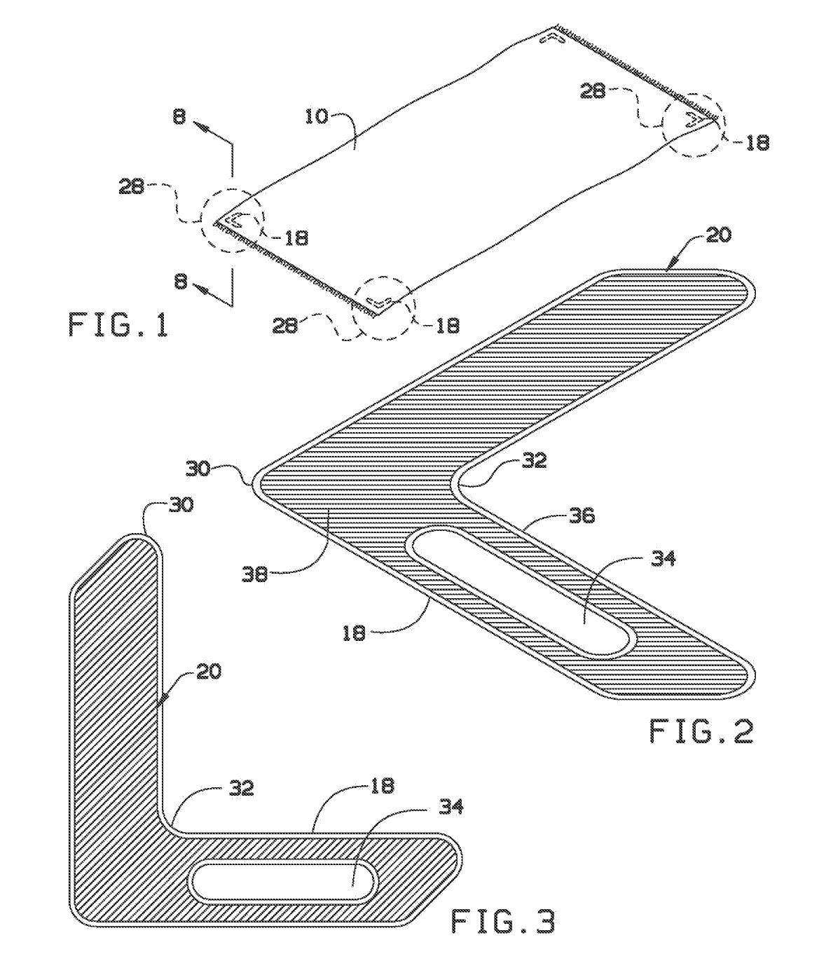

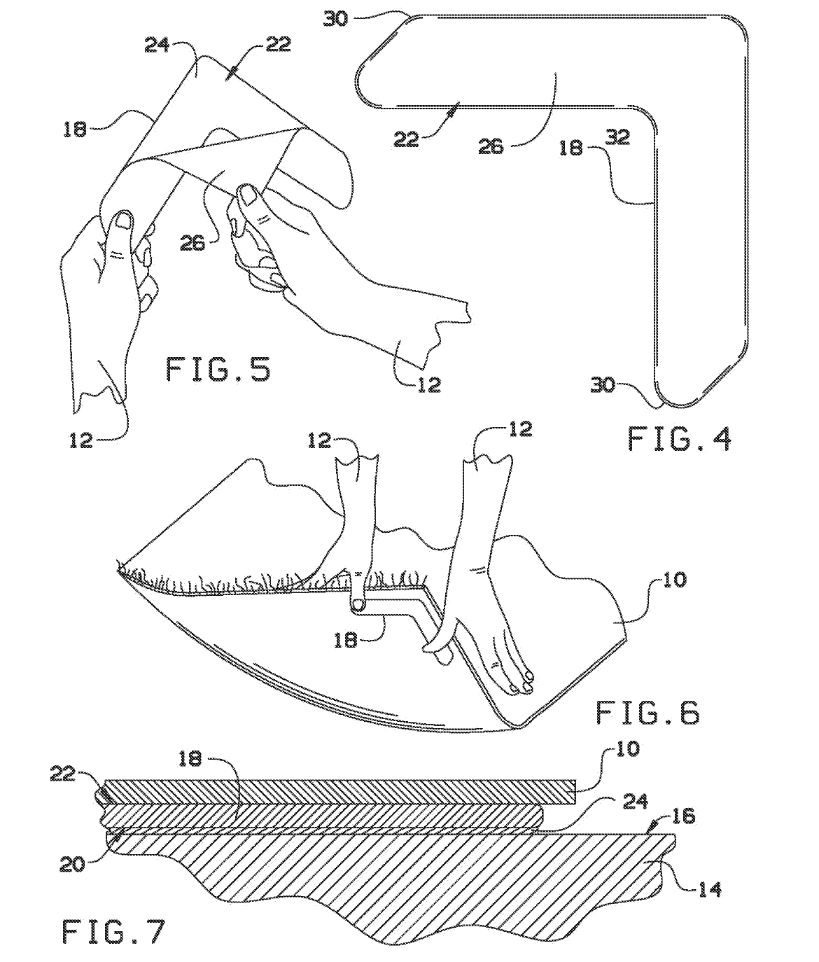

Referring now to FIGS. 1 through 7, an anti-curling device 18 may be applied to the corners of a rug 10 to prevent the corners 28 of the rug 10 from curling. The device 18 may be made of various materials, such as metal, plastic, composite or the like. Typically, the device 18 may be made of a polypropylene material. The device 18 may have a floor side 20 and an adhesive side 22. The floor side 20 may include ridges, as shown in FIGS. 2 and 3. In some embodiments, a logo area 34 may be provided to allow a logo to be printed on the device 18.

The device 18 may be shaped generally in an L-shape, with the length of each leg of the L-shape being from about 2 inches to about 10 inches long and from about 1 to 3 inches wide. Other sizes may be contemplated within the scope of the present invention. The ends of the L-shape may be angled from about 30 to about 60 degrees, typically about 45 degrees. The thickness of the device 18 may vary, with the floor side 20 having a rounded shape, where the center of the device 18 has a greater thickness than toward the edges of the device 18.

The device 18 may include outside rounded corners 30 and an inside rounded corner 32. The rounded corner design may provide a device that is gentle on almost any floor surface 16 of almost any floor 14. The outside rounded corners 30 can also increase the adhesion between the device and the back of the rug 10, while making the device 18 safer to handle before applying it to the back of the rug 10. A raised border may be provided on the floor side 20, with rounded edges about the entire periphery of the device 18.

The floor side 20 may include several elements that can be combined to reach a desired effect. A half-moon design can radiate at an approximate 45 degree angle to increase the rigidness of the device 18 while allowing airflow between the device 18 and the floor surface 16. The half mood design intersects with the raised border at an approximate 45 degree angle to strengthen the edges and equalize the height of the device 18.

An adhesive backing 24 may be disposed on the adhesive side 22 of the device 18. The adhesive side 22 of the device 18 may be designed with chatter marks (not shown) that enable the adhesive to firmly adhere properly to the adhesive side 22. An adhesive backing film 26 can cover the adhesive backing 24 until ready for use. The adhesive backing film 26 can pull off the adhesive backing 24, exposing the adhesive backing 24 and allowing the device 18 to be applied to a corner of the rug 10 by a user 12, as shown in FIG. 6.

The adhesive backing 24 can have a polyester scrim approximately 0.23 mm (about 9 mil) thick that adds additional reinforcement to the device and holds the adhesive together to remain stable until installation.

The application of the device 18 can be achieved by removing the non-adhesive backing 26 and placing the device 18 with the adhesive side 22, with the adhesive 24, onto the underside of a problem corner 28 of the rug 10. The device 18 may be placed either directly at the corner or within about 1-2 inches of the corner, for example.

The device 18 performs its desired function by adding weight to the problem corner of the rug 10. By adding weight, combined with the stiffness of the device 18, the rug corner lies flat and does not curl.

The device 18 may be prepared by conventional process, such as injection molding, for example, in aluminum blocks that may be brought together to form a cavity. In some embodiments, the two aluminum blocks that make up the injection molding mold can be cooled at different rates to create a gentle, curving, airfoil effect. Once completely cooled, the devices can be removed from their mold for final finishing and application of the adhesive.

In an exemplary embodiment, a user can use the device of the present invention in the following manner. First, the user can reverse roll the curled area of the rug and then immediately unroll and pull back to expose the bottom of the rug corner. The user can then carefully remove the non-adhesive covering from the back side of the device without touching the adhesive. The user can then firmly press the device to the problem corner of the rug, with the adhesive side in contact with the rug. The user can then simply lay the corner flat on the floor to solve the curled rug corner problem. When properly installed, the device is not visible under the rug when laid flat.

It should be understood, of course, that the foregoing relates to exemplary embodiments of the invention and that modifications may be made without departing from the spirit and scope of the invention as set forth in the following claims.

What is claimed is:

1. A device for treating and preventing corner curl in rugs, the device comprising:
a device body having an L-shape with outside rounded corners and an inside rounded corner, the device body having a floor side and an adhesive side;
an adhesive disposed on the adhesive side of the device body; and
an adhesive backing disposed over the adhesive, the adhesive backing adapted to be removed to expose the adhesive.

2. The device of claim 1, wherein ends of the device body are angled between about 30 and about 60 degrees.

3. The device of claim 1, further comprising a logo area disposed on the floor side of the device body.

4. The device of claim 1, further comprising rounded edges about the periphery of the device body.

5. The device of claim 1, further comprising ridges cut into the floor side of the device body.

6. A method for preventing or eliminating curling at corners of rugs, the method comprising:
removing an adhesive backing disposed over an adhesive applied to a device body of an anti-curling device, the device body having an L-shape with outside rounded corners and an inside rounded corner, the device body having a floor side and an adhesive side;
applying the adhesive to a bottom of the rug at a corner thereof, where the L-shape of the device body follows along the corner; and
turning the rug back over with the floor side of the device body toward a floor surface.

7. The method of claim 6, further comprising:
rolling the rug in a direction opposite a curl direction at a corner of the rug; and
turning the rug over to expose a bottom of the rug at a corner.

8. The method of claim 6, wherein the anti-curling device includes rounded edges about the periphery of the device body.

9. The method of claim 6, wherein the anti-curling device includes ridges cut into the floor side of the device body.
